(19) United States
(12) Patent Application Publication
(10) Pub. No.: US 2011/0301926 A1
(43) Pub. Date: Dec. 8, 2011

(54) METHOD OR SYSTEM TO EVALUATE STRATEGY DECISIONS

(75) Inventor: Mark Chussil, Portland, OR (US)

(73) Assignee: Advanced Competitive Strategies, Inc., Portland, OR (US)

(21) Appl. No.: 12/841,951

(22) Filed: Jul. 22, 2010

Related U.S. Application Data
(60) Provisional application No. 61/352,380, filed on Jun. 7, 2010.

(51) Int. Cl. G06G 7/48

(52) U.S. Cl. 703/6

(57) ABSTRACT

Briefly, embodiments of a method or system to evaluate strategy decisions are disclosed.

### RELATED PATENT APPLICATION

This patent application claims priority to U.S. provisional patent application Ser. No. 61/352,380, filed Jun. 7, 2010, by Mark Chussil, titled “METHOD OR SYSTEM TO EVALUATE STRATEGY DECISIONS,” assigned to the assignee of the currently claimed subject matter.

### FIELD

Claimed subject matter is related to evaluating strategy decisions.

### BACKGROUND

Current tools available for strategists to evaluate decisions have a number of shortcomings. Typically, such tools, such as spreadsheets, “gap” analysis or Monte Carlo simulations, for example, do not perform well for decisions that repeat and may involve interactions with others. A need exists for a method or technique for evaluating approaches to handling decisions such as these, particularly in strategic ways.

### BRIEF DESCRIPTION OF THE DRAWINGS

Claimed subject matter is particularly pointed out and distinctly claimed in the concluding portion of the specification. However, both as to organization or method of operation, together with objects, features, or advantages thereof, it may best be understood by reference to the following detailed description if read with the accompanying drawings in which:

FIG. 1 is a flowchart showing an embodiment of a system in which an evaluation of a strategy may be performed.

FIG. 2 is a plot illustrating strategy dominance for an example embodiment;

FIG. 3 is a plot illustrating evaluating robustness for an example embodiment;

FIG. 4 is a table corresponding to the plot of FIG. 3;

FIG. 5 is a table showing an example statistics report for an example embodiment;

FIG. 6 is a table showing another example statistics report for an example embodiment; and

FIG. 7 is a schematic diagram illustrating an example embodiment of a computing platform, such as a special purpose computing platform.

Reference is made in the following detailed description to the accompanying drawings, which form a part hereof, wherein like numerals may designate like parts throughout to indicate corresponding or analogous elements. It will be appreciated that for simplicity or clarity of illustration, elements illustrated in the figures have not necessarily been drawn to scale. For example, dimensions of some elements may be exaggerated relative to other elements for clarity. Further, it is to be understood that other embodiments may be utilized. Furthermore, structural or logical changes may be made without departing from the scope of claimed subject matter. It should also be noted that directions or references, for example, up, down, top, bottom, and so on, may be used to facilitate discussion of the drawings and are not intended to restrict application of claimed subject matter. Therefore, the following detailed description is not to be taken to limit the scope of claimed subject matter or their equivalents.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, or systems that may be known by one of ordinary skill have not been described in detail so as not to obscure claimed subject matter. While subject matter described below is illustrated through application to competitive markets, for example, claimed subject matter is not so limited. It is intended that embodiments of a method of evaluating strategic decisions in accordance with claimed subject matter may be applied to situations other than competitive markets, such as cooperative situations, markets that are not fully competitive, etc. This may also become clearer from the description provided below.

Reference throughout this specification to “one embodiment” or “an embodiment” means that a particular feature, structure, or characteristic described in connection with an embodiment is included in at least one embodiment of claimed subject matter. Thus, appearances of the phrase “in one embodiment” or “an embodiment” in various places throughout this specification are not necessarily all referring to the same embodiment. Furthermore, particular features, structures, or characteristics may be combined in one or more embodiments.

Some portions of the detailed description which follows are presented in terms of algorithms or symbolic representations of operations on binary digital signals stored within a memory of a specific apparatus or special purpose computing device or platform.

In the context of this particular specification, the term “specific apparatus” or the like includes a general purpose computer after it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, quantities may take the form of electrical or magnetic signals capable of being stored, transferred, combined, compared or otherwise manipulated. It has proven convenient at times, principally for reasons of common usage, to refer to signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of a special purpose computer or similar special purpose electronic computing device.

Strategists, such as business strategists, may employ various forms of ad hoc analysis if evaluating a given decision. Examples may include: financial spreadsheets, market research, “gap” analysis, econometric forecasting, etc. However, it may be challenging to test or evaluate strategy alternatives which may be employed to provide a basis for a decision. Employing a group of human decision-makers in an evaluation process may take hours or more to evaluate a given scenario, limiting for practical reasons of time how many scenarios may be considered. Moreover, human decision-making may at times be inconsistent or imprecise. Therefore, a process involving human decision-makers may not provide as accurate or as robust results as may be desired without repetition or analysis to address risk of inconsistency or lack of precision

Additional challenges exist to evaluating strategic decisions. Conventional analytic tools do not adequately address complexity present in real world situations. For instance, a financial spreadsheet assumes no competitive response. Gap analysis—a “gap” being a difference between what a customer wants and what a product provides—does not typically account for time or costs to respond, for changes in customer preferences, or, again, for competitive response. Likewise, conjoint or Monte Carlo simulations generally work with continuous situations, as opposed to disruptive or discontinuous change. Furthermore, typically, analytic tools, or at least analysts' objectives, try to eliminate or reduce variability in predicted outcomes, as though variability represents experimental error. As a result, strategists may be surprised if real-life outcomes diverge from conventional predictions. They may fail to appreciate that variability may be difficult to satisfactorily address, if not impossible to eliminate fully, for inherently volatile, or even chaotic, conditions.

Conventional tools may work if the future looks like the past, but may not adequately address situations if the future looks different than the past. However, a number of challenging strategic problems may fall into this latter category. It would also be desirable to have an approach or method for evaluating strategic decisions that provides a capability to explore a broad variety of scenarios or strategy alternatives and that, as a component of decision making, is able to take into account responses to a decision by others. Likewise, an approach that is not limited to commerce or even competition may likewise be desirable. An approach able to handle a variety of interactions, such as working towards common goals, preferences that are partially but not completely common, a variety of different objectives, etc., may be desirable. Having an ability to model or simulate situations in which parties interact repeatedly and in which they are able to comprehend outcomes of previous interactions may be desirable.

State of the art simulators may include some of the following disadvantages, although additional disadvantages may also be present:
They may be “hard-wired” for specific situations. Analysts may not be able to customize or adapt for situations they may actually face or experience.
They may be limited to simplified situations, such as a Prisoners' Dilemma-type game. Typically, trying to reflect more complex situations over time may result in a level of computational complexity that may make it difficult or potentially infeasible to solve using standard software executing on a standard hardware platform, for example. Furthermore, employing representative, random samples of simulations may miss “clusters” of results that may be desirable to be aware of for purposes of evaluation.
They may not include strategy-search capabilities that permit a simulation to modify itself using real-time results to formulate improved evaluation.
They may assume parties being simulated are competitors. They may not allow for combinations of competitive, cooperative, or indifferent parties.
They may assume a small number of “measures of success,” such as profitability or market share, and may use only one. Many real-life situations may involve more measures with potential for tradeoffs. Likewise, employing proper scaling of trade-offs itself may produce challenging issues for strategic evaluation.
They may not provide sufficient details to enable effective evaluation of simulation produced outcomes.
They may not provide a capability to compare successful strategies with unsuccessful strategies so that differences may be evaluated or between multiple potentially successful strategies.
They may not provide a capability to compare desired outcomes from a given strategy with undesired outcomes from the same or a similar strategy due at least in part to multiple scenarios at least in part resulting from, for example, actions by other parties, and, thus, may not assist in revealing what may lead a strategy to perform well or badly.
User interaction may be cumbersome, time-consuming, or impractical for real-time applications.
They may not have a capability for users to conduct interactive “what-if” evaluations; this capability, for example, may have value for entertainment, education, strategy exploration and analysis, or research.

Although claimed subject matter is not limited in scope in this respect, in at least one embodiment, a strategy decision evaluation system (SDES) may be operated by someone who desires to evaluate potential outcomes of applying a particular strategy to resolve a particular decision that may have potential to arise in a particular situation, referred to here as an analyst. Strategies or decisions to be evaluated may come from an analyst or from those participating in a decision for a particular situation. Of course, an analyst or a participant in a decision may also comprise teams of individuals or an entity. Likewise, in at least one embodiment, a strategy decision evaluation system may itself be able to operate as a decision participant or situation actor, in effect, as explained in more detail below.

In at least one embodiment, an analyst may set up, calibrate, operate or interpret results from a system or an SDES. In at least one embodiment, a decision participant may comprise an entity, such as a person, a team, or a process, that may select a strategy decision to be evaluated. As alluded to above, in at least one embodiment, an SDES may include one or more situation actors, and may typically, but not necessarily, include one or more decision participants; although claimed subject matter is not limited in scope in this respect.

In at least one embodiment, a system or an SDES may calculate outcomes of simulated behavior of situation actors. An actor in this context may comprise more than an individual or an entity. An actor may comprise anyone or anything that may potentially affect resulting outcomes for a simulated scenario or situation. As an example, without limitation, an actor may in a simulation comprise a market. Likewise, although this is not intended to provide an exhaustive list in any sense, other examples of actors may include a stock market; weather; a political party; a sports team; a government; a governmental entity; a city; a county; a political subdivision; a business; a regulator; a factory; a machine; a not-for-profit entity; an individual; a voter; a customer; a market; a market segment; a homeowner; a charity; or a committee or team of decision makers. Likewise, some actors may comprise combinations, such as a homeowner and a voter, as one simple, non-exclusive example. A simulation may, for example, simulate behavior of two or more actors that may interact. An analyst or a participant may select a strategy decision for one or more actors. In any combination: actors may or may not be known to each other; may be cooperative, competitive, or indifferent; or may care about measures of success that are similar, dissimilar, or both. Without intending to provide an exhaustive lists, in any given scenario or situation, therefore, at least one of the following may apply at least partially: ideal market competition; non-ideal market competition; non-market competition; collaboration; cooperation; independent behavior; disinterested behavior, or combinations thereof. In at least one embodiment, although claimed subject matter is not limited in scope in this respect, a participant may devise a strategy decision for itself as an actor within a simulation.

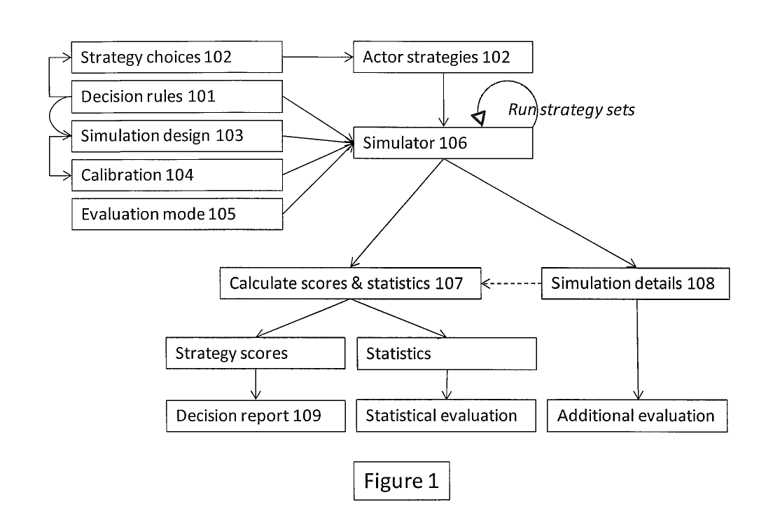

In at least one embodiment, such as embodiment 100 illustrated in FIG. 1, for example, 9 conceptual components may be employed, although, this is intended as an illustrative embodiment. Therefore, claimed subject matter is not intended to be limited to only the features described. Components 101 through 105 may be employed to set up an evaluation to be performed or executed by a system or an SDES. Components 106 and 107 may be employed to execute an evaluation. Components 108 and 109 may be employed to display results or facilitate further evaluation.
1. Decision-rule component 101. This component in at least one particular embodiment may permit one to describe a set of sufficiently specified decision-rule options for sufficiently specified situations or scenarios. In this context, sufficiently specified refers to being specified in a manner so that a computing device, such as a special purpose computing device, is capable of implementing. Illustrative examples are provided later. However, sufficiently specified, for example, may include a set of conditions, attendant circumstances, outcomes or results so that it is clearly specified what to do or what happens for complete set of possibilities or outcomes that may arise. Decision rules may be combined to form a decision-rule strategy to be evaluated. One or more decision rules may be executed as often as desired under control of an SDES-type system during an evaluation. In this context, a simulator may comprise a computer or computing device programmed to execute a simulation as described in more detail below. Therefore, a simulator may comprise a special purpose computing device or computing platform, for example. In at least one embodiment, an actor may follow a particular decision rule in a given time period, but may follow different decision rules in different time periods in an evaluation. Decision rules or strategies may be arbitrarily complex in an evaluation, so long as in combination they are sufficiently specified.
2. Participant strategy choices and actor strategies file component 102. This component in at least one particular embodiment may permit a participant or an analyst to select one or more sufficiently specified strategies to be simulated. Strategies may be selected in any combination for various actors in a simulation evaluation. A specific combination of strategies, one per actor in at least one embodiment, may be referred to in this context as a strategy set. Desired participant strategy choices or options may be saved in a situation actor strategies file in at least one embodiment. This may permit, for example, actor strategies to be stored so they may be run one or more times through a simulation for an evaluation. Moreover, because a file may be edited or enlarged, in at least one embodiment, a system may be employed to reasonably or more efficiently evaluate additional combinations of strategies, and because simulated conditions may be modified or varied, in at least one embodiment, a system may be employed to reasonably or more efficiently evaluate strategies under different conditions (e.g., scenarios, as described in component 104).
3. Simulation design and simulation details file component 103. This component in at least one particular embodiment may permit a system to calculate an outcome of a strategy set and store simulation details for evaluation. Simulation details may include any quantities calculated by a simulation, including specified measures of success.
4. Simulation calibrating component 104. This component in at least one particular embodiment may permit one to calibrate a simulation to be evaluated. In this component, relationships, such as actor relationships, may be specified so that strategies may be evaluated. Calibration refers to entering values for parameters in a specified relationship; for example, expected market growth or population growth. Specific settings in a calibration may also be included as part of a scenario or situation.
5. Evaluation mode component 105. This component in at least one particular embodiment may permit a simulation to be executed. In at least one embodiment, a system may perform various evaluations based at least in part on detailed simulation results. Examples include tournament mode, candidate mode, team mode, head-to-head mode, or exploration mode. In at least one embodiment, depending at least in part on a particular evaluation mode, a simulator may execute: all possible combinations of strategies, groups of strategies against other groups of strategies, or a search for better performing strategies. In at least one embodiment, depending at least in part on a particular evaluation mode and depending at least in part on the number of strategies, a simulator may execute an exhaustive evaluation, an evaluation using a random sample of strategies, or perform an evaluation during real-time execution to focus on strategies that appear more promising than others using real-time execution results, as explained in more detail later.
6. Simulation execution component 106. This component in at least one particular embodiment may permit execution of a requested simulation for a scenario. A computer or computing device programmed to execute this component in this context comprises a simulator. It is able to execute as many simulations as desired. Executing of requested simulations by a simulator in this context is referred to as is a strategy decision evaluation.
7. Scores and statistics component 107. This component in at least one particular embodiment may permit calculation or ranking of scores that show performance or other attributes of strategies included in a strategy decision evaluation. These scores may include one or more measures of success. Measures of success may include any quantifiable outcome, such as profitability, sales growth, economic growth, win/loss percentages, etc., in any combination. Therefore, again, while not intending to provide an exhaustive lists, one or more quantifiable measures may at least partially involving at least one of the following: market share, profits, revenue, costs, market capitalization, economic growth, cash flow, return on investment, customer satisfaction, employee satisfaction, win-loss percentage, stock price, election results, accident rates or combinations thereof. Different participants may have different preference weights for measures of success, in any combination. Summary statistics regarding measures of success or other simulation outcomes may provide various results of interest to an analyst. Examples, without limitation, may include average outcomes achieved, differences between high-performing and low-performing strategies, etc.
8. Output files component 108. This component in at least one particular embodiment may permit storage of scores, summary statistics, outcomes evaluation, or other simulation details to memory files for display or further evaluation.
9. Report component 109. This component in at least one particular embodiment may permit evaluation of a given participant's strategy or of an overall strategy decision evaluation comparing multiple possible strategies. A report may cover one or more scenarios. Moreover, analysts may develop customized reports.

In at least one embodiment, components 101 to 109 may be employed to set up an evaluation of a strategy for a particular embodiment, such as embodiment 100, as explained in more detail below. FIG. 1 is a flowchart showing an embodiment in which an evaluation of a strategy may be performed, although, again, claimed subject matter is not limited in scope to this particular embodiment. This is merely an example for illustration purposes.

A series of purposeful decisions may be represented or modeled as a decision rule. A decision rule in this context refers to a formal description of how an actor in a system, such as an embodiment of an SDES, may be modeled to make decisions. For example, a decision rule may specify a set of conditions, outcomes, results or attendant circumstances, which if one or more of those were to come to pass as a result of simulation execution, an adjustment, change or modification may occur within the context of the simulation of a feature or aspect being modeled or simulated as within domain or control of an actor In this particular embodiment, a decision rule may be characterized in terms such as, if . . . then . . . else, although claimed subject matter is not limited in scope in this respect. In another embodiment, a decision rule may take another form other than if . . . then . . . else, although in terms of content it may embody a similar decision rule. For instance, below is an embodiment of a decision rule that expresses the classic tit-for-tat (TFT) strategy in a two-actor situation or scenario:

If this is the first move or time period, then do nothing.

Else, do whatever the other actor did in the previous time period or move.

This example illustrates a decision rule that sufficiently specifies a strategy decision so that it may be implemented or executed by a simulator without involving human judgment or further human input (e.g., without any human intervention).

In at least one embodiment of an SDES, a decision rule may be made arbitrarily complex. Likewise, it may take advantage of information made available as a result of executing or performing a simulation. For example, below is an example of one of many ways to implement TFT in a multi-actor scenario:

If this is the first move or time period, then do nothing.

Else, look at the moves made by the other actors in the previous move or time period.

If there was a most-common move, then do that.

Else, do nothing.

This example of a decision rule may be employed, for example, to resolve ties. A decision rule may, likewise, emulate an actor in terms of a measure of success, an actor in terms of a particular measure of size, an actor who made less frequent moves (e.g., changed decision strategies less), etc. A decision rule may be applied or formulated that comprises an average of that of other actors (e.g., match an average donation to a charity), that tracks another actor (e.g., keep up with the most extreme actor), or applies a multiple of another actor (e.g., bid 5% above the highest bid of the other actors in an auction). A decision rule may also be applied in which limits are placed (e.g., never set a price above $X or below $Y, never change a budget by more than $Z from one time period to the next).

Of course, decision rules are not limited to variations on a TFT approach. A decision rule may ignore what other actors do. (Example: if our costs go down by X %, cut our price by 0.9×X %.) A decision rule may be proactive; that is, it may be chosen to induce behavior by other actors. (Example: make a conciliatory move, then wait; if another actor reciprocates, make another conciliatory move.) A decision rule may also be reactive in a manner unlike TFT. (For instance, a decision rule may be applied to react to actors who are not competitors, such as political party shifting its policies to fit voters' shifting preferences.) A decision rule may react to outcomes-so-far during a simulation (e.g., go in the opposite direction if results, according to a particular measure of success, have declined by 15% since the start). Etc.

In at least one embodiment, a decision rule may apply to an actor in a time period, although claimed subject matter is not limited in scope in this respect. Likewise, a participant may be allowed to select one or more decision rules for an actor over multiple time periods. For example, an actor may apply rule 1 for time periods 1 through 4, rule 2 for periods 5 through 8, and rule 3 for periods 9 through 12. A strategy may be employed to comprise a set of decision rules for an actor sufficiently specified so that it is clear how to implement via a special purpose computing device for any period of simulation. In the example above, it may comprise the sequence of rules 1, 2 and 3. It may be employed to define an actor's decisions for a relevant time span.

Based at least in part on having decision rules, as indicated above, a system, such as an SDES, may apply decision rules to implement relevant decisions or determine outcomes for a particular scenario. Furthermore, any number of participants (or an SDES itself) may change any number of strategies, and a system, such as an SDES, may execute or re-execute relevant decisions or outcomes.

In at least one embodiment, participants may select from a set of decision-rule options to construct or formulate a strategy. In at least one embodiment, a decision-rule option may comprise a decision rule chosen from a list or menu. For at least one embodiment, if a decision includes five decision rules for a given participant, the participant has five decision-rule options.

Decision rules may be formulated from a variety of sources. For example:

Concepts in game theory.

Interviews with experts.

Brainstorming.

Hypotheses.

Rules applied previously in real life.

Recommendations from consultants.

Trend lines, periodic events, or random events.

For example, a company may chose to solicit competitive-strategy approaches from personnel in its marketing department. Competitive tournaments may be executed or run to assist in a process to formulate a strategy. For example, a tournament may be set up to formulate a decision rule for household investments in situations in which factors exist outside a household's control, such as employment, health, home prices, etc. In this example, decision rules may be specified for an investment manager, the job market, the health of those in the household, etc. Of course, this is merely an illustrative example and claimed subject matter is not limited in scope to this example.

Using decision rules may provide a number of advantages, although claimed subject matter is not limited in scope to employing decision rules only in situations where these advantages may exist.
Clarity or completeness in thinking may result.
Rich behavior or interactions may be identified. For example, there may be a large number of possible combinations of decision rules in a decision set or rules with which rich content may be formulated.
More realistic simulations may become possible to implement without employing significant human intervention. For example, rules may be able to capture acting or reacting in accordance with a human's directives.
Problems that may be difficult or infeasible to simulate or analyze through other approaches may become capable of being simulated. Imagine that a business may chose to raise, cut, or hold its price, and it may also raise, cut, or hold its marketing budget. That provides 9 permutations in a given period. Over a 12-quarter time horizon (e.g., 3 years), there are 282,429,536,481 permutations; assuming, for simplification purposes, that competitors do not react to a business' price moves, etc. For a typical laptop computer, it may take over 5 months to calculate these permutations and associated outcomes. This assumes 20,000 simulations per second may be calculated. However, many of the permutations above are trivial or not likely to be implemented. Decision rules may, therefore, make it possible to run more-meaningful or more-realistic simulations in a fraction of the time. Intelligent searching, as explained in more detail below, for at least one embodiment may also speed up evaluation further for larger problems.
Evaluating additional options or simulating more complex behavior by additional or more complex decision rules may become facilitated.
Better strategic analysis may be enabled. Adding decision rules may allow a system, such as an SDES, to “learn” by experimenting with different behavioral options. As more decision rules are formulated to capture more complex behavior, more robust results may be generated with an improved likelihood that deeper or greater insight may be gained.
A survey or investigative aspect may likewise exist. In general, one would expect individuals to select or formulate decision rules that reflect the manner in which they may typically make a decision.

In at least one embodiment, after a series of decision rule options are formulated, participants may chose among them to develop a strategy. As described above, a time horizon may call for a participant to choose one or more decision rules. A participant's combination of choices for at least one actor, covering a time horizon, in this context is referred to as a strategy; a combination of participants' strategies in this context is referred to as a strategy set or a decision set.

Decision rules may embody rich, complex behavior. No conceptual limit exists to the number of decision rule options that may be devised or simulated. In at least one embodiment strategy decisions may involve merely choosing from a menu of decision-rule options available for a portion of a time horizon. Speed or simplicity, such as this, for example, in addition to being desirable for a user, also may be desirable for possible search features, as may be implemented in at least one embodiment, described in more detail below.

As an example, imagine there are 15 decision rules available in 3 time periods over a time horizon. Depending at least in part on the embodiment, options may be the same, partly the same, or different for a particular time period, and may be the same, partly the same, or different for participants. For this example, however, a participant may have 15×15×15, or 3,375, possible strategies.

For at least one embodiment, for example:
Various strategies may be made available and those strategies may be arbitrarily different from one another. In contrast, many decision-analysis techniques tend to offer minor variations on a few strategies.
A participant may be able to relatively efficiently devise a strategy among various strategy options. This may be desirable for decision-makers who may be busy and would prefer to make selections quickly, for example.
Ease of devising a strategy may make “what-if” evaluations of multiple strategies relatively easy as well, as discussed in more detail below.

In at least one embodiment, selections from menus of decision rule options may be stored for later use. Take the example of 15×15×15 options. If a participant were to develop a strategy by selecting options 7, 11, and 2, a system, such as an SDES, may in at least one embodiment store options 7, 11, and 2 plus bookkeeping information, such as who developed the strategy, which may be used in additional evaluations, as discussed in more detail later.

Storing strategies permits additional simulations to be more conveniently set up and executed. Examples:
100 people may, for example, in a company or at a conference devise strategies for a particular problem. A system in at least one embodiment may use an actor strategies file, in which 100 strategies, for example, may be stored, as specifications for running one or more simulations. Now another 40 people may devise strategies for the same scenario. The additional 40 strategies may be evaluated separately or they may be added to the 100 strategies. In effect, the latter in an embodiment may permit an evaluation to “grow” and potentially provide more robust results.
A participant may wish to devise multiple strategies. He or she could enter those strategies and permit the simulator to evaluate performance against strategies contributed by others or devised in accordance with an embodiment of an SDES.
An analyst may wish to change scenarios or conditions, but not change decision strategies. For example, if a market grows faster or slower than expected a scenario may change. In at least one embodiment, scenarios conditions or strategies may be changed without affecting the other.
   An actor strategies file has no conceptual limit on complexity other than available memory space.

In at least one embodiment, a user interface may be employed that allows participants to choose strategies to evaluate. In at least one embodiment, strategies may be selected independently or separate from performing simulation of strategies. A system, such as an SDES, for example, in at least one embodiment, may employ any convenient or meaningful approach to allow participants to choose strategies.

In at least one embodiment, a strategy-choice user interface may be implemented using these or other techniques:
A web site interface may be employed in an embodiment. For example, in an embodiment employing a web-site interface, large-scale decision evaluation, such as tournaments or research projects, may be evaluated if participants are geographically or temporally dispersed, as in multinational organizations, for example
An electronic form created using Microsoft Excel® software, Microsoft Word® software, Adobe Acrobat® software, or another program, may be employed. A form may be crafted to, in effect, walk a participant through a decision-making. In an embodiment, an interface such as this, for example, may be convenient for use over email or the like.

A decision evaluation may include one or more measures of success. A business simulation might evaluate sales growth, or it might evaluate sales growth and profitability, for example. For multiple measures of success, weights or tradeoffs may be contemplated in at least one embodiment. Likewise, different participants may chose to employ different definitions of success in an embodiment.

In an embodiment, a system, such as an SDES, may employ multiple methods by which participants may express definitions or measures of success. In effect, in an embodiment, there need not be any limit to the manner in which a participant may chose to define success or make tradeoffs. A particular embodiment is described in more detail below; however, claimed subject matter is not limited in scope to a particular approach. Details are provided for purposes of illustration.

Below are illustrative examples of methods by which a participant may express a definition or measure of success, if desired.
A simple sum or average of measures of success may be employed. This may work if measures are expressed in the same terms (e.g., dollars). It does not work if measures are in different terms (e.g., win/loss percentage, team salaries).
A preference-weighted average of measures of success may be employed. This may work if measures are expressed in the same terms. It may allow a participant to indicate that some measures (e.g., win/loss percentage) may be preferred over others (e.g., percentage of games completed).
An average or preference-weighted average percentile score may be employed. This method may work if measures are expressed in different terms (e.g., dollars of profit, percentage of market share, rating of customer satisfaction). After calculating results, in an embodiment, percentile ranking of a strategy on a measure may be calculated. An average or a weighted average of rankings may be applied
A relationship may be employed, such as an equation in closed form, curves, limits, etc. No conceptual limit on complexity exists in an embodiment employing this approach.

In an embodiment, one of the latter two methods may be desirable for combining different measures of success expressed as different sets of values that may be more challenging to compare directly, although, of course, claimed subject matter is not limited in scope to merely the approaches discussed.

In at least one embodiment, additional information about participants may be collected. Examples: demographic information (location, age, experience), predictions about decision evaluation outcomes, date at which a strategy was formulated, etc.

In at least one embodiment, if desired, information collected may be employed to evaluate if characteristics of participants appear to affect results. For example: do participants in one country outperform others? Do older participants outperform younger? Do participants predict outcomes well? Do participants with some characteristics predict outcomes better than participants with other characteristics? This capability may permit one, for example, to compare decision-making skills of groups of people, which typically is different from comparing the decisions themselves. For illustration, without an SDES one may be able to ascertain whether people whose first names are early in the alphabet select strategies that are different from those chosen by people whose first names are late in the alphabet; however, through employing an SDES one may also be able to ascertain whether early-in-alphabet people select strategies that are better or worse than late-in-alphabet people.

In at least one embodiment, control mechanisms may be employed (e.g., processes for specifying simulations, running the simulations, calculating performance scores, file and error handling, and so on) common to any evaluation. Common mechanisms may make it more cost- or time-efficient to set up or perform an evaluation. For example, as may now be apparent, a wide array of decision strategies may be addressed in a particular embodiment in accordance with claimed subject matter.

In any particular scenario, of course, decision rules are typically formulated specifically for that scenario, although claimed subject matter is not limited in scope in this respect. Strategic problems typically may be different and may also employ different measures of success, etc. In an embodiment, a simulation may calculate outcomes for a strategy (that is, any combination of decision rules) on relevant measures of success. Calculations may be made completely independent of control mechanisms in any given embodiment, although claimed subject matter is not limited to such an approach, of course.

A simulation may typically be expressed as a computer operation or program executing on a computer or computing platform. For example, an embodiment may comprise a special purpose computer or computing device programmed to perform or execute a simulation. Specifics of calculations performed by a simulation may have a variety of possible sources. Claimed subject matter is not limited in scope to a particular source or set of calculations. However, subject-matter experts, statistical relationships, hypothetical interactions, etc. may provide one or more bases for one or more sets of calculations implemented by a particular simulation, for example.

Three features may be desirable for a simulation, although claimed subject matter is not limited in scope in this respect.
1. It may be desirable for a simulation to be able to execute without significant human interaction. This may be desirable for efficiency of execution.
2. It may be desirable for a simulation to perform calculations independent of which combination of strategies or other information for execution may be supplied. This may be desirable for a similar reason as above.
3. It may be desirable for an actor's behavior to not depend on knowledge of contemporaneous behavior of another actor. This may be desirable to reflect or simulate effectively real-world situations or scenarios.

In at least one embodiment, a simulation may apply a strategy set (e.g., sufficiently specified strategies for multiple participants) in a calibrated scenario, as explained in more detail below. A participant's strategy may be employed to simulate behavior in a calibrated scenario and consequential performance on one or more measures of success.

As an example, imagine that an analyst desires to simulate strategies for two-actor auctions for nice bottles of wine. The auction is ended if 1) one actor bids at least $15 more than the other party or 2) neither actor is willing to go higher. In case of a tie, the auction is awarded randomly to one of the actors.

| Strategy 1 | Strategy 2 |
|---|---|
| Make an initial bid of $50. | Make an initial bid randomly between |
| If that doesn't win, add | $35 and $65. |
| $10 to the previous bid. | If that doesn't win, add a random |
| Do not go over $100. | amount between $1 and $15 to the |
| | previous bid. |
| | No upper limit. |

There are two measures of success in this illustration: 1) the number of auctions won (higher is better) and 2) the total cost paid in the auctions (lower is better). Either or both strategies may be simulated without human interaction. Likewise, a simulation may reach a sensible conclusion in this example, even if A and B, actors, chose the same strategy, no matter which one. Below we describe how this example auction, with those example strategies, may be simulated in at least one embodiment, although claimed subject matter is not limited in scope to this example. This example is provided for purposes of illustration only. Assume A chooses strategy 1, and B chooses strategy 2.

| Time | | | Auction | |
|---|---|---|---|---|
| Period | A's bid | B's bid | over? | Comments |
| 1 | $50 | $39 | No | A's bid is only $11 over B's |
| 2 | $60 | $46 | No | B increases randomly $0-$15 |
| 3 | $70 | $58 | No | |
| 4 | $80 | $60 | Yes | A is more than $15 over B |

Likewise, an auction may occur as follows:

| Time | | | Auction | |
|---|---|---|---|---|
| Period | A's bid | B's bid | over? | Comments |
| 1 | $50 | $48 | No | |
| 2 | $60 | $62 | No | |
| 3 | $70 | $68 | No | |
| 4 | $80 | $81 | No | |
| 5 | $90 | $90 | No | Equal but willing to go up |
| 6 | $100 | $104 | No | Not equal again; continue |
| 7 | $100 | $106 | No | B doesn't know A's limit |
| 8 | $100 | $111 | No | |
| 9 | $100 | $118 | Yes | |

In period 5, A and B are tied but it is not clear if the auction is resolved. If A and B had the same bids in period 6, the auction would be resolved. B, of course, does not know of a $100 limit in A's strategy. If B knew it, then B could jump to $115 in period 7 instead of paying $118 in period 9. If we ran those two simulations in a strategy-decision evaluation, results would be as follows in this simple example:

| | A | B |
|---|---|---|
| Auctions won | 1 | 1 |
| Cost | $80 | $118 |

Of course, this example is intended to illustrate a simulation, not a full strategy-decision evaluation. Therefore, one should not conclude that A necessarily chose a better strategy than B. A full strategy decision evaluation may offer more strategies with more simulations.

Although claimed subject matter is not limited in scoped in this respect, in at least one embodiment, a simulation may be “called” in a loop in accordance with a simple protocol to permit retrieval of simulation results. Any computer language, of course, may be employed to implement a simulation. In at least one particular embodiment, a protocol may execute or perform six operations, although, again, claimed subject matter is not limited in scope in this respect.
1. An operation to communicate the strategy a given participant has chosen for an actor. This operation may execute at least once for a simulation actor before execution in at least one embodiment.
2. An operation to communicate to a simulation to reset calculations. This clears results of prior simulations in at least one embodiment.
3. An operation to communicate to a simulation to execute.
4. An operation to communicate to a simulation to store unevaluated results in a simulation-details file.
5. An operation to communicate to a simulation to retrieve results of a given simulation from a simulation-details file.
6. An operation to communicate whether a simulation completed execution or encountered a problem before completing execution.
   In pseudo code, one example embodiment of a protocol may include the following (numbers in parentheses correspond to functions above for an example embodiment), although, again, claimed subject matter is not limited in scope in this respect:

// Run simulations
For one or more actor

For one or more participant with a strategy for that actor

Tell simulation participant's strategy (1)

End For // This loop sets up strategy sets
Reset calculations (2)
Run simulation (3)
Retrieve completion code(6)
If completion code indicates error

Then inform user and halt
Else continue

Save results in simulation details file (4)
Increment count of simulations performed

End For
// Evaluate simulations
For simulations // Use count of simulations performed

Retrieve results from a simulation details file (5)
Process results

End For

Although claimed subject matter is not limited in scope in this respect, simulation results may be stored in a simulation-details file for at least one embodiment.
It may be desirable for disk storage to be employed rather than memory, such as RAM. For example, large problems may consume hundreds of gigabytes or more.
It may be desirable for results from any number of decision evaluations to be stored for later review, for backup, etc.
It may be desirable for simulation results to be capable of being provided to others while also providing security and flexibility with respect to operation or execution of software executing on a platform, for example.
   Execution may involve multiple passes through a simulation-details file, as described in more detail later.

In at least one embodiment, it may be desirable to calibrate a simulation, although claimed subject matter is not limited in scope in this respect. Typically, a simulation implementation may include:
Logic for decision rules. As discussed previously, logic may be arbitrarily complex and there may be any number of decision rules.
Relationships to be employed to calculate outcomes; e.g., measures of success. Again, these may be arbitrarily complex and there may be any number of measures of success. A measure of success may be on any scale, as described in more detail later.
   Calibration refers to inserting values for parameters. In the auction example above, for example, one parameter may comprise the $15 premium.

Premium=[get value from calibration]

If bid(A)−bid(B)>premium then winner=A

Else if bid(B)−bid(A)>premium then winner=B

Else winner=None//If so, continue to another bid

In an alternate embodiment, continuing with this example for purposes of illustration, the $15 premium may not be handled as a calibration:

If bid(A)−bid(B)>15 then winner=A

Else if bid(B)−bid(A)>15 then winner=B

Else winner=None//If so, continue to another bid

In the former or first example embodiment, conditions may be varied. For example, a user interface may be employed change a value of a premium parameter. In the latter or second example embodiment, the premium may be set in stone, so to speak, and may not be changed conveniently, which may limit flexibility in various situations.

An embodiment may accommodate both variable and set parameters, so to speak. Those that are variable may be altered using a user interface, for example. As discussed previously in connection with a user interface for strategy choices, this operation may be implemented via various media or via various pre-existing or to be developed programs.

Typically, for an embodiment, participants would not be given access to a calibration user interface. Having an ability to alter a calibration for decision evaluation, combined with storing actor strategies and simulation results, provides flexibility so that that an analyst, for example, may run “what-if” type evaluations. Whereas a system, such as an SDES, may be employed to evaluate strategies, an embodiment in which calibration may take place may allow an analyst to evaluate varying scenarios or conditions in addition to strategies. For instance, in the above example, does auction-strategy 1 beat auction-strategy 2 if a premium is $5 as well as at $15? An ability to evaluate strategies or situations in a particular embodiment may provide a higher level of insight, such as: how good is strategy X versus strategies Y and Z, and, under what conditions, if any, should a strategy shift be considered?

An embodiment of a system, such as an SDES, may include a variety of modes to perform a variety of types of evaluation. A case selected or construct for illustration purposes is employed here to discuss various possible modes, although claimed subject matter is not limited in scope to these particular modes. Many other modes are possible and may be employed in alternative embodiments.

Imagine that you have just been elected to Congress and you desire to explore strategy decisions for a freshman representative. You devise 20 decision-rule options, such as: stick to the party line, appeal to the party “base,” be a “maverick,” vote according to opinion polls, etc. You pay attention to 3 other freshman representatives from your state because they are your competition, if you want to move to the Senate. The other 3 representatives will select their own strategies from the same list. You expect 30 significant pieces of legislation during your 2-year term. A measure of success comprises a combination of approval ratings and volume of legislation a representative assisted in having passed.

Using terminology discussed previously, in this illustrative example, there are 4 actors. The actors may choose from 20 strategies that may be applied over a span or time horizon of 30 periods. We refer to actors in this example as A1-A4. It is, of course, understood that claimed subject matter is not limited in scope in any way to this example.

You, as a participant, for purposes of simulation, play one of the actors. You like 4 of the strategy options, and would like to evaluate them. Your strategies shall be referred to as PY1-PY4.

Now suppose you collect 100 former representatives and ask each of them to select one strategy from 20 options. You want to evaluate their ideas as well as your own. So, you now have 104 options for an evaluation: PY1-PY4 (the 4 strategy options you nominated) and PR1-PR100 (the strategy selections from the 100 former representatives). PR1-PR100 are of interest at least in part as indicative of a strategy a representative may select, as discussed previously, and you use them for the other 3 actors (that is, the other 3 representatives who will vie with you for the Senate seat in 2 years).

In at least one embodiment, modes may include tournament mode, candidate mode, team mode, head-to-head mode, or exploration mode; although, again, claimed subject matter is not limited in scope to only these modes. Other modes are possible in other embodiments and claimed subject matter is intended to cover other possible modes.

In at least one embodiment, a tournament mode may be employed to evaluate strategy performance. It may be employed to obtain a range of results possible to be compared or contrasted for strategies capable of being selected by participants. Although claimed subject matter is not limited in scope in this respect, in an embodiment, this mode may runs all combinations of strategy selections from participants, in the above example of 104 participants. For an embodiment, the order in which simulations are executed typically does not matter, and therefore may not be a feature, although claimed subject matter is not limited in scope in this respect. Continuing with the example above, output information regarding simulations executed may, for example, look like the following (changes from one line to the next are in bold). Of course, again, this is merely an illustrative example and claimed subject matter is not limited in scope to this example representation:

| Sim# | Actor 1 | Actor 2 | Actor 3 | Actor 4 |
|---|---|---|---|---|
| 1 | PY1 | PR1 | PR2 | PR3 |
| 2 | PY2 | PR1 | PR2 | PR3 |
| 3 | PY3 | PR1 | PR2 | PR3 |
| 4 | PY4 | PR1 | PR2 | PR3 |
| 5 | PR1 | PR1 | PR2 | PR3 |
| 6 | PR2 | PR1 | PR2 | PR3 . . . |
| . . . 104 | PR100 | PR1 | PR2 | PR3 |
| 105 | PY1 | PR1 | PR2 | PR4 |
| 106 | PY2 | PR1 | PR2 | PR4 . . . |
| . . . 208 | PR100 | PR1 | PR2 | PR4 |
| 209 | PY1 | PR1 | PR2 | PR5 . . . |

In this example, there would be 18,938,816 simulations from using all 104 strategies (PY1-PY4 and PR1-PR100) for 4 actors. In an embodiment, redundant simulations may be omitted; for instance, PY1-PR1-PR2-PR3 gives the same results as PY1-PR3-PR2-PR1. Otherwise, there would be 116,985,856 simulations. However, other embodiments may execute simulations that are or may seem redundant, for example, if desired (for example, to simplify finding a specific simulation result in a resulting file of executed simulations).

In at least one embodiment, a candidate mode may be employed to evaluate strategy performance if other participants assuming actor roles are taken into account. It may be employed to obtain a range of results, for example, possible with other candidate strategies. Continuing with the example above, your strategies (PY1-PY4) may be executed against all combinations of strategy selections from the 100 other participants (PR1-PR100). Again, continuing with the example above, output information regarding simulations executed may, for example, look like the following (changes from one line to the next are in bold). Of course, again, this is merely an illustrative example and claimed subject matter is not limited in scope to this example representation:

| Sim# | Actor 1 | Actor 2 | Actor 3 | Actor 4 |
|---|---|---|---|---|
| 1 | PY1 | PR1 | PR2 | PR3 |
| 2 | PY2 | PR1 | PR2 | PR3 |
| 3 | PY3 | PR1 | PR2 | PR3 |
| 4 | PY4 | PR1 | PR2 | PR3 |
| 5 | PY1 | PR1 | PR2 | PR4 |
| 6 | PY2 | PR1 | PR2 | PR4 . . . |
| . . . 393 | PY1 | PR1 | PR3 | PR4 |
| 394 | PY2 | PR1 | PR3 | PR4 |
| 395 | PY3 | PR1 | PR3 | PR4 . . . |
| . . . 396 | PY4 | PR1 | PR3 | PR4 |
| 397 | PY1 | PR1 | PR3 | PR5 . . . |

In this example, there would be 646,800 simulations, from using 4 strategies for actor 1 (PY1-PY4) and 100 strategies for actors 2-4 (PR1-PR100). In an embodiment, redundant simulations may be omitted, as mentioned. Otherwise, there would be 4,000,000 simulations. However, again, other embodiments may execute simulations that are or seem redundant in candidate mode, for example.

In at least one embodiment, a team mode may be employed to evaluate strategy performance on a group basis. It may be employed to obtain a range of results possible about characteristics or tendencies of groups relative to others. Let's modify our Congressional example. Instead of you, as 4 participants, having 4 strategies (PY1-PY4), you pose your problem to 5 classrooms of political science students. A class may behave as multiple participants with strategies, for example: 4 participants per class, as an illustrative example. Participants from class 1 may be referred to as PC1, participants from class 2 may be referred to as PC2, etc. 4 participant strategies for class 1 may be referred to as PC1.1, PC1.2, PC1.3, and PC1.4, for example.

Using this example, strategies from a group may be (using n for the number of participants in a group, for example, as follows: PC1.1-PC1.n, PC2.1-PC2.n, etc.) against all combinations of strategy selections from the 100 other participants (PR1-PR100). In a particular embodiment, simulations may be executed like multiple runs of candidate mode, described above. However, a comparison of groups (classes, in this example) may take place in an embodiment, for example. Employing this mode, for example, may make an embodiment applicable to competitions among businesses, schools, teams, or other groups or organizations.

In at least one embodiment, a head-to-head mode may be employed to evaluate strategy performance on a group basis, but in a manner different than team mode, for example. It may be employed to obtain a range of results possible about characteristics or tendencies of groups relative to others.

Continuing to illustrate with a modification of the example above, (e.g., 5 classes of students, 4 participants per class), this mode may run all strategies from a group (PC1-PC5) against all combinations of strategies from the other groups. In other words, PC1 strategies may be executed against strategies from PC2-PC5; PC2 strategies may be executed against strategies from PC1, PC3, PC4, and PC5; PC3 strategies may be executed against strategies from PC1, PC2, PC4, and PC5; etc. This mode is similar to team mode in that groups of strategies might be evaluated; however, in an embodiment, team mode may evaluate a team's strategies in conjunction with a separate group of strategies (PR1-PR100 in the example). However, in an embodiment, head-to-head mode may evaluate a team's strategies against another teams' strategies. In other words, head-to-head evaluation mode may permit focus on business, school, team, group, or organization performance against other businesses, schools, teams, groups, etc.

For one or more embodiments described above, modes may be used that involve simulations of strategies selected for actors by participants. But what if one wants to find a strategy, as opposed to evaluate specific strategies? For example, if there are many strategy possibilities, it may not be useful or feasible to evaluate most or all of them. Likewise, it may be that participants are not as innovative as possible at formulating a strategy, for example.

In at least one embodiment, a system, such as an SDES, may be employed to assist in identifying a better strategy. A strategy may typically be devised or formulated to succeed in accordance with a particular measure of success. In one embodiment, for example, a system may search for a strategy for one or more actors in context of or in context relative to strategies for remaining actors. Hence, a feature, as indicated previously, for an embodiment, may include taking into account possible actions or reactions by one actor another actor. A variety of methods to search for a strategy may be applied. Claimed subject matter is not limited in scope to a particular approach; however, in an embodiment, any one or a combination of the following approaches may be employed: exhaustive, random, or improvement searches.
In an exhaustive search, in at least one embodiment, all possible strategies for one or more actors may be executed.
In a random search, in at least one embodiment, strategies for one or more actors may be selected at random. If an exhaustive search involves executing a relatively small number of simulations, a random search is not needed. However, for computationally large situations, a random search may provide a beneficial mechanism to explore strategies.
In an improvement search, in at least one embodiment, a system, such as an SDES, may progressively narrow its search as it learns from executing simulations. An advantage of an improvement search is that adjustments may be made as outcomes or other simulation detailed results are accumulated; time spent evaluating strategies that may not produce desirable results may potentially be reduced.

In at least one embodiment, a search for a strategy may be conducted for one or more actors in context of what one or more other actors may do. Since a strategy may typically be devised to succeed in accordance with a particular measure of success, a strategy may be executed for one or more actors relative to one or more other actors, again, referred to here as “context” or “in context.” A variety of methods to execute strategies for context-actors may be applied. Claimed subject matter is not limited in scope to a particular approach; however, in at least one embodiment, an exhaustive or random approach may be applied. Likewise, in an embodiment, strategies may come from all possible strategies available or from a selection of strategies. For a selection of strategies, it may be useful or desirable to consider strategies that participants believe actors may choose to follow. Thus, in an embodiment, four context approaches, representing different combinations, may be applied; although, of course, claimed subject matter is not limited to these approaches. It is intended that other approaches be included within the scope of claimed subject matter.

| | | |
|---|---|---|
| Exhaustive | All | Evaluate what other actors might do in |
| | possible | accordance with all strategy options available. |
| | Select | Evaluate what other actors might do, using all |
| | | participant choices of strategy options. |
| Random | All | Evaluate a random subset of what other actors |
| | possible | might do drawn from a list of available strategy |
| | | options. |
| | Select | Evaluate a random subset of what other actors |
| | | might do drawn from a list using participant |
| | | choices of strategy options.. |

If there are many options from which to choose and many scenarios, an improvement search may offer a mechanism to identifying a strategy that may have beneficial results. In an embodiment, an advantage of an improvement search may relate to how evaluating alternative possible strategies may be useful to accomplish desired objectives: typically, differences in approach or strategy are sought that are more likely to be impactful to results. In contrast, as an example, with Monte Carlo simulations, there may be many or even infinite gradations to apply, but most of the simulations may be trivially or marginally different from one another and discontinuous, abrupt, disruptive or categorical changes may be a challenge to simulate.

In an embodiment, an improvement search may have the following features, although claimed subject matter is not limited in scope in this respect:
An SDES does not require that it be possible to mathematically “solve” relationships or equations.
Ruling out good strategies as a result of identifying local optima should not occur; rather, multiple effective strategies may be identified.
Strategies expressed as decision rules allow evaluation of arbitrarily different strategies, including aspects of strategies that may vary in more fundamental aspects, rather than fine-tuning components of a strategy in contrast with, for example, genetic-process or similar approaches. Improved search efficiency may therefore be possible.

The previously described example situation may be used to illustrate an embodiment of improvement searching. In the Congressional example described above, 4 actors may choose from a list of 20 strategies. The number of strategy combinations, without redundancies, is 4,845. An exhaustive evaluation in an embodiment may therefore be employed with a short amount of execution time, e.g., seconds or less.

However, if an analyst desires a participant to be able to change decision rules mid-course (e.g., after the first 15 pieces of legislation), more computational burden may be involved. In this modified example, a strategy may comprise one decision rule for the first 15 proposed laws, and a second decision rule for the second 15. A participant now has 400 possible strategies (20 decision rules×20 decision rules). This would produce 1,050,739,900 strategy combinations without redundancies (as high as 25,600,000,000 with redundancies). It may take 15 hours, for example, to execute all combinations without redundancies (15 days with them). If there were 5 actors instead of 4, if there were 30 decision rules (thus 30×30 strategies), if there were 2 opportunities to change decision rules instead of 1 (thus 20×20×20 strategies, or 30×30×30), an exhaustive search of all possible alternatives or variations may become prohibitive or infeasible to conduct.

In such a situation, as an example, a combination of an improvement search and random context may be applied for an embodiment. For one actor, whose strategy evaluation is being sought, for example, an improvement search may be employed; for the other three actors, a random context approach, such as described above, may be applied. Thus, for this example, strategies at random may be selected for 3 actors. In an embodiment, this may be implemented in a manner so that no strategy combinations are duplicated; although claimed subject matter is not limited in scope to this necessarily.

For an embodiment, one may specify how many simulations to execute or for how long to execute simulations, for example. An improvement search may be implemented as follows, using the previous example to illustrate:
1. 20 decision rules for a first time period (the first 15 proposed laws) are made equally probable. 20 decision rules for a second time period are made equally probably. Therefore, in this example, 400 strategies (20×20) are equally probable.
2. A decision rule for a first period is selected at random, and a decision rule for a second period is selected at random. Strategies for the other actors are selected using random context. A simulation is executed.
3. If the first simulation is being executed, an improvement search records outcomes for the relevant actor. Otherwise, an improvement search evaluates if outcomes are above or below an average of previously executed simulations. If above, probabilities of selecting the first- and second-period decision rules are modestly increased. If below, probabilities are modestly decreased. In one embodiment, a probability is not reduced such that the selected decision rules will never be chosen again. Likewise, a probability may not be made so high such that the selected decision rules become the only decision rules that will be chosen in the future.
4. If enough simulations have been run or the time limit has been hit, in one embodiment, as previously described, for example, conclude execution. Otherwise, go back to 2 above.

Pseudo code for implementation of an embodiment is provided below; however, claimed subject matter is not limited to a particular embodiment or implementation. Pseudo code is provided primarily for illustrations. For example, the following assumptions for simplification are employed in this example implementation: one actor is searched, one time period is employed, and there is one measure of success. Other embodiments in which assumptions such as these are relaxed is intended to be included within the scope of claimed subject matter, of course.

// Common variables

| | |
|---|---|
| probs[ nDecRules ] | // probabilities for decision rules |

| | |
|---|---|
| drSelect | // decision rule selected |

// Function to select decision rules for actor
Function SelectDecRules

probTot = 0
For each decision rule (dr)

probTot = probTot + probs[ dr ]
If dr = 1 then probCum[ dr ] = probs[ dr ]
Else probCum[ dr ] = probCum[ dr − 1 ] + probs[ dr ]

Next dr
ran = random number 0..1 x probTot
For each decision rule (dr)

If ran > probCum[ dr ]

Check next decision rule

Else

drSelect = dr
Exit For loop

End Else

Next dr

End function
Function SmartSearch

| | |
|---|---|
| minProb = 1 | // minimum probability for a decision rule |
| maxProb = 100 | // maximum probability |
| begProb = 50 | // beginning probability |
| step = 1 | // size of adjustment |

nSims = 0 // # of simulations run so far
outTot = 0// running total of outcome measure
// Initialize probabilities
For each decision rule (dr)

probs[ dr ] = begProb

Next dr
// Run simulations (by # of simulations or time limit)
For each simulation-to-be-run

nSims = nSims + 1
Randomly select strategies for other actors
Call SelectDecRules for actors
Run simulation
outTot = outTot + actor's performance
outAvg = outTot / nSims
If actor's performance > outAvg

Then adjust = step

Else if actor's performance < outAvg

Then adjust = −step

Else adjust = 0
probs[ drSelect ] = probs[ drSelect + adjust
probs[ drSelect ] =

maximum (minProb, minimum(maxProb, probs[ drSelect]))

Next simulation
End function

Values such as minProb, maxProb, and begProb may be adjusted in a variety of ways. Claimed subject matter is not limited to employing constant values or a particular approach to executing adjustments of these values.

Although claimed subject matter is not limited in scope to a particular embodiment, beneficial features of an embodiment, such as previously discussed, for example, may include the following:
Experience may be accumulated and employed as a result of execution simulation.
A decision rule is not set to be eliminated from consideration (unless minProb is set to 0).
Decision rules may rise or fall in favor, so to speak, in accordance with accumulated results.
Performance may be continually improved. In execution of an embodiment, such as indicated by the previous pseudo code example implementation, outTot and outAvg, for example, may trend up.
Any number of decision-rule options and actors may be included in an evaluation.
Any simulation model (e.g, relationships employed to calculate measure of success outcomes) may be used in an evaluation.
   An embodiment may also reduce redundancies in simulations if there are groups of identical actors. Redundancies within groups of identical actors may therefore be reduced, if desired.

In an embodiment, executing an evaluation of a strategy decision may involve a series of computing or logic operations. For example, an embodiment may verify or validate a specification provided in an actor strategies file. An actor strategies files may be created in a text format in one embodiment. Therefore, it is possible that an actor strategies file contains errors. Examples of errors may include selecting non-existent strategy options, out-of-range values, or too few or too many selections. It is also possible to select a mode that is inconsistent with an actor strategy (e.g., selecting an improvement search but there are few enough possibilities to run an exhaustive search).

In an embodiment, before running a simulation, a system, such as an SDES, may check what it is being asked to execute. If errors are identified, it may report them and halt. If errors are not identified, it may provide a brief summary of what will be executed and commence execution. In an embodiment, a system may also periodically report progress.

An embodiment may include a capability to evaluate detailed simulation results. In an embodiment, this may be “in-line” or after simulations have been run, as explained in more detail below. For example, in an embodiment, simulation results may be stored in a file to conserve random access memory. In an embodiment, if a simulation were to fail for some reason, such as running out of disk space, a user may be alerted and may also be informed where an error is indicated to have occurred. Likewise, strategy decision evaluation may be halted.

In an embodiment, results may be calculated and scores may be ranked that show performance or other attributes of strategies included in an evaluation. These scores may include one or more measures of success. Measures of success may include any quantifiable outcome, as previously described, such as profitability, sales growth, economic growth, win/loss percentages, etc., in any combination. Different actors may also have different preference weights for measures of success, in any combination, as previously described. A statistical analysis may indicate various results of interest in an embodiment, such as average outcomes achieved, differences between high-performing and low-performing strategies, etc.

After running simulations, a system, such as an SDES, may process results to provide insights regarding a strategy decision. Results may be provided from the perspective of an actor whose strategy decision is being evaluated. In an embodiment, therefore:
A simulation typically may correspond to one of the actor's strategy options being executed against a given scenario, that is, a combination of the other actors' moves.
Simulations for an actor's strategy options may be scored and combined.
Simulations for those options may also be contrasted.
   In an embodiment, a system, such as an SDES, may process a results file several times as it conducts the following:
Determining minima or maxima on various measures for an actor without regard to strategy decision. For example, some measures of success (e.g., sales or profits) may have no a priori upper or lower bounds. Range limits may therefore facilitate counting number of simulations in “bands” of performance, which later may be translated into percentiles. Using an inline process, however, a sample of the simulations to approximate minimum and maximum range limits may be taken in real-time rather than waiting for execution to complete. Those limits might therefore be not fully accurate, which may skew subsequent calculations. However, in contrast, a benefit of an in-line process may be a shorter execution time.
Counting or accumulating the occurrence of an actor's strategy decision in a percentile band. This accumulation may be done separately for an actor's possible strategy decision options, and may use range limits, for example. Range limits therefore may permit a contrast of strategy options on a uniform scale.
Calculating performance or robustness scores for an actor's possible strategy decisions. Performance may comprise an average percentile score for simulations run on a strategy decision. Robustness may comprise a measure of dispersion. Robustness, for example, may be proportional to certainty that a decision will produce a given level of performance. If all simulations fall into a single band, robustness would be 100%. If all simulations were evenly dispersed among all bands, robustness would be 0%.
Calculating statistics to summarize an evaluation. These statistics may include overall measures of success in raw numbers, such as sales, or in performance scores, using a percentile-range technique.
Calculating an analysis of variance to show how various independent variables, such as choice of strategy, may affect raw or percentile performance. Those may, for example, be done with 1 independent variable (1-way splits) or 2 independent variables (2-way splits).
Sorting an actor's strategy options by overall performance score. A list may display overall performance, robustness, or other metrics as relevant.
Determining whether an actor could improve its performance by switching to one or more other strategies, and identifying which strategies and estimating extent of possible improvement. This calculation may identify strategies better on individual or combined measures of success; that is, whether an actor should consider a sacrifice of performance on one measure of success to improve another, or whether an actor may improve performance on all measures of success concurrently. These results identify weak or strict (or strong) dominance, respectively.
Determining what's different between scenarios where a given strategy performs well for an actor and the same or similar scenarios for the same or similar strategies perform poorly or not so well. Analysis may assist in identifying aspects to which performance of a particular strategy may be sensitive, for example. A strategy may perform well in scenarios with strong market growth and might not perform well otherwise. In that example, an analyst may conclude that, for a strategy to succeed, market growth should be strong. An analysis may also conclude that alternate strategies should be considered if market forecasts indicate slow growth.
   In an embodiment, an evaluation may complete if one of two conditions occurs.
1. An error forces a system to halt before completing (or even beginning) a simulation.
2. A system finishes running, analyzing, and writing output files for executed simulations.
   A user may typically be informed in either situation.

In an embodiment, a system, such as an SDES, may generate files that contain scores, summary statistics, evaluation results, or simulation details. In an embodiment, files may be generated in a variety of formats, including, without limitation in TXT (text), CSV (comma-separated value), or BIN (binary) formats. TXT or CSV formats are readable. CSV format is harder to read, but is useful for use with for Excel or other programs. A simulation-details file may be generated in BIN format as well. BIN is more compact and a simulation-details file may be large. Likewise, BIN is faster to process generally.

Here is what a generated file may contain in at least one embodiment:

| | |
|---|---|
| Strategy scores | Performance scores |
| | Robustness scores |
| | List of weakly dominating strategies |
| | List of strictly or strongly dominating strategies |
| | Sorted list of strategies' performance |
| Statistics | Summary statistics |
| | 1- or 2-way analysis of variance |
| | Comparisons of strategies |
| | Analysis of strategy sensitivity |
| Simulation | Details of simulations, such as, for example, |
| details | scenario or strategy information. |

In an embodiment, a report may be generated to evaluate a participant's strategy. Of course, as mentioned previously, a participant may also comprise the system itself, in an embodiment. Reports may cover one or more scenarios.

In an embodiment, for example, through an interface, a user may select a strategy scores file to download or select a participant's strategy to highlight for evaluation. Relevant information may be provided in a text or graphic format and may also include:
Overall performance scores, taking into account preference weights on measures of success (if there are 2 or more measures).
Performance scores on measures of success, raw, percentile or both.
Strict dominance: such as how many (if any) other strategies strictly dominated a participant's strategy and how much better the participant's performance would be if she or he switched strategies. In this context, a strategy is referred to as strictly dominating another if it is at least as good on all measures of success and better on at least one. In this context, a strategy is referred to as weakly dominating another if it is better on at least one measure of success but worse on one or more others.
Weak dominance.
A strategy's robustness on measures of success.
Tradeoffs between a strategy's robustness and its average performance on measures of success.
Identification of factors that affect a strategy's performance sensitivity, or degree to which factors may affect sensitivity.
A sorted list of performance for strategies evaluated.

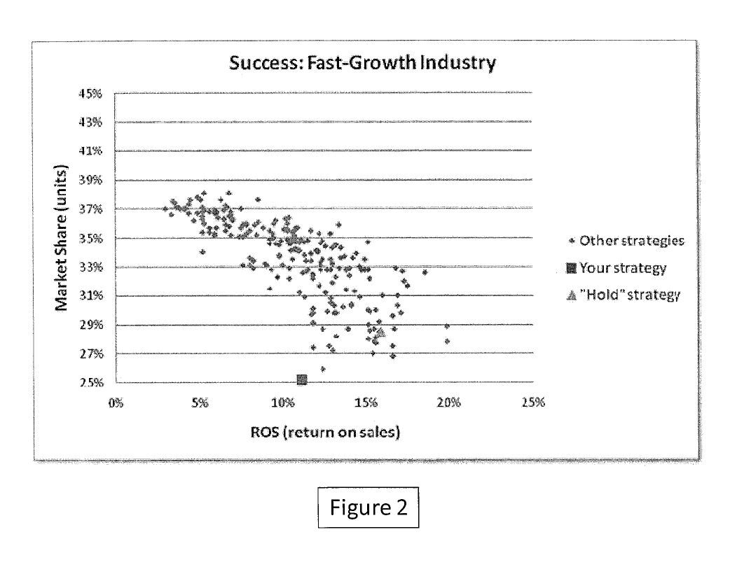

FIG. 2 is a sample chart or plot showing dominance. In this sample, a dot represents results of 36,585 simulations for each of 270+participants' strategies. An embodiment may produce a chart similar to this, although claimed subject matter is not limited in scope in this respect.

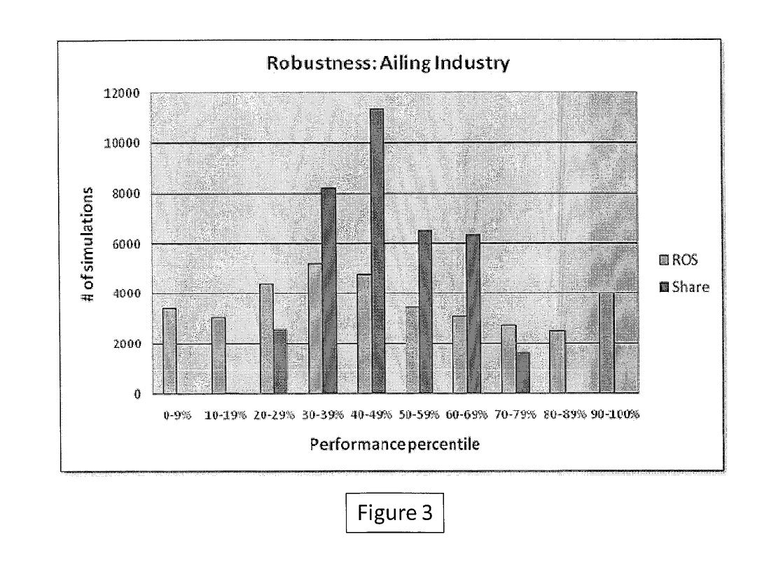

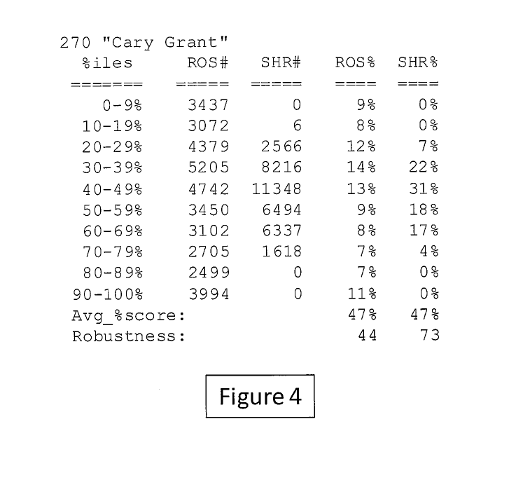

FIG. 3 is a sample chart or plot that summarizes robustness results of various strategy options, also illustrated by a table in FIG. 4. It comes from a sample tournament-style evaluation in which relevant measures of success were ROS (return on sales, a profitability metric) and SHR (market share). A pseudonym “Cary Grant” refers to a participant (he is #270 out of more than 270) who selected the strategy being simulated. These results, for readability, collapse “bands” down to 10 from a larger number generated. In this case, there are 36,585 simulations for Mr. Grant's strategy (as there were for the more-than-270 other strategists). A total of the ROS# column is 36,585, as is a total of the SHR# column. Those columns show the number of simulations falling into decile performance percentages by measure of success. Corresponding percentages are shown in the ROS % and SHR % columns. Results show a wider dispersion for Mr. Grant's ROS results than for his SHR results: the latter is highly concentrated in the middle deciles, and the former is scattered among all the deciles. Hence, these results indicate that this strategy has much lower robustness for ROS than for SHR. An embodiment may produce a table similar to this, although claimed subject matter is not limited in scope in this respect.

Several aspects are illustrated that distinguish decision strategy evaluation in accordance with claimed subject matter from other approaches:
A more thorough evaluation is done than decisions typically receive due at least in part to the number of simulations that may be executed.
Decisions may be evaluated using performance scores or robustness scores. For example, Mr. Grant's strategy performed, overall, worse than 206 other strategists', putting it well below average.
The impact of Mr. Grant's strategy decision may be distinguished from impact of other actors' strategy decisions. Mr. Grant's strategy produces, on average, scores of 47 for both ROS and SHR. Whether his strategy ends up performing above or below that is a function of what other actors do. 36,585 simulations here permits evaluating actions and reactions.

In an embodiment, multiple scenarios may also be reported if run with parallel specifications. For instance, one scenario may comprise fast market growth, another slow market growth, and a third negative market growth. A combined report may contrast how a given strategy would perform under those scenarios. A multiple-scenario capability therefore may be a desirable feature for an embodiment. Likewise, in an embodiment, performance scoring or sensitivity analysis, as previously described, for example, may enhance this feature.

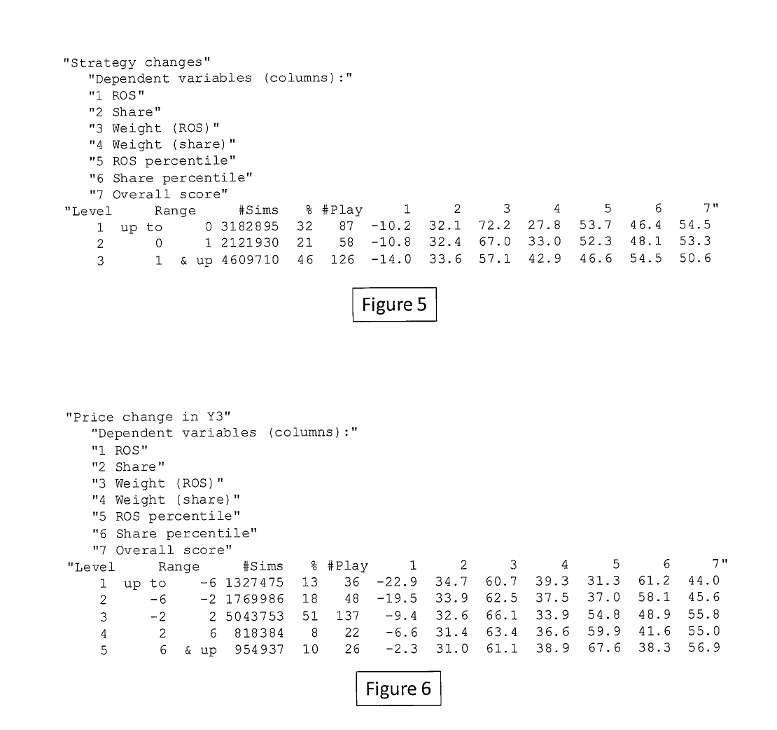

FIG. 5 is a table which illustrates for an embodiment a summary of changing decision rules mid-stream for a strategy in comparison with sticking with selected decision rules. It covers 9,914,535 simulations in a particular decision-strategy evaluation. For example, 87 participants made no mid-stream changes, 58 made 1 change, and 126 made 2 the maximum for this strategy-decision evaluation example). Comparing columns 5 and 6 (or 1 and 2, which are related raw performance information) indicates that changing strategies may be mildly advantageous for market share and disadvantageous for profitability. An embodiment may produce a table similar to this, although claimed subject matter is not limited in scope in this respect.

FIG. 6 is a table which illustrates a summary of effect of an independent variable (e.g., in this example, price change in year 3) on 7 dependent variables. It covers 9,914,535 simulations in this particular evaluation of over 270 participants' strategies. Participants' strategy decisions led to 1,327,475 simulations that resulted in a steep price cut (at least 6) in year 3. Relatively few (36) participants chose strategies that led to aggressive cuts. At the other extreme, there were 954,937 simulations, from 26 participants, that raised price by at least 6 in year 3. Looking down columns 5 and 6 indicates that those who cut price were likely to perform relatively badly on profits (ROS) and relatively well on share (SHR): 31.3 and 61.2 versus 67.6 and 38.3. An embodiment may produce a table similar to this, although claimed subject matter is not limited in scope in this respect.

In an embodiment custom reports are possible, such as by using TXT format for tables, CSV format in Excel, or BIN format with other software. Quotation marks (“) make import into Excel convenient, for example.

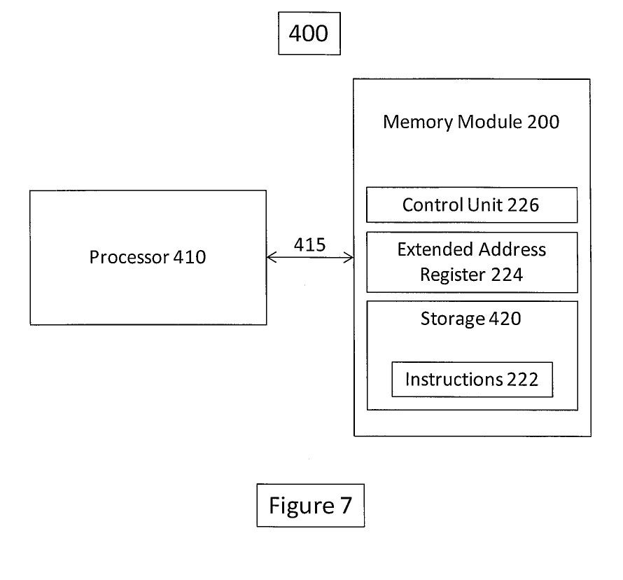

FIG. 7 is a schematic block diagram depicting an example embodiment of a system or computing platform 400, such as a special purpose computing platform, for example. Computing platform 400 comprises a processor 410 and a memory module 200. Likewise, of course, multi-core processors or multiple processor systems may also be employed in an embodiment to provide performance enhancements. Memory module 200 for this example is coupled to processor 410 by way of a serial peripheral interface (SPI) 415. For one or more embodiments, memory module 200 may comprise a control unit 226 and an extended address register 224. Memory 200 may also comprise a storage area 420 comprising a plurality of storage locations. Further, memory 200 may store instructions 222 that may comprise code for any of a wide range of possible operating systems or applications, such as embodiments previously discussed, for example. The instructions may be executed by processor 410. Note that for this example, processor 410 and memory module 200 are configured so that processor 410 may fetch instructions from a long-term storage device. In an alternate embodiment, processor 410 may include local memory, such as cache, from which instructions may be fetched.

For one or more embodiments, control unit 226 may receive one or more signals from processor 410 and may generate one or more internal control signals to perform any of a number of operations, including read operations, by which processor 410 may access instructions 222, for example, or other signal information. As used herein, the term “control unit” is meant to include any circuitry or logic involved in the management or execution of command sequences as they relate to a memory device, such as 200. Of course, other embodiments are likewise possible and intended to be included within the scope of claimed subject matter.

The term “computing platform” as used herein refers to a system or a device that includes the ability to process or store data in the form of signals. Thus, a computing platform, in this context, may comprise hardware, software, firmware or any combination thereof. Computing platform 400, as depicted in FIG. 4, is merely one such example, and the scope of claimed subject matter is not limited in these respects. For one or more embodiments, a computing platform may comprise any of a wide range of digital electronic devices, including, but not limited to, personal desktop or notebook computers, laptop computers, network devices, cellular telephones, personal digital assistants, and so on. Further, unless specifically stated otherwise, a process as described herein, with reference to flow diagrams or otherwise, may also be executed or controlled, in whole or in part, by a computing platform.

The terms, “and,” and “or” as used herein may include a variety of meanings that will depend at least in part upon the context in which it is used. Typically, “or” if used to associate a list, such as A, B or C, is intended to mean A, B, and C, here used in the inclusive sense, as well as A, B or C, here used in the exclusive sense. Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, the particular features, structures, or characteristics may be combined in one or more examples. Examples described herein may include machines, devices, engines, or apparatuses that operate using digital signals. Such signals may comprise electronic signals, optical signals, electromagnetic signals, or any form of energy that provides information between locations.

In the preceding description, various aspects of claimed subject matter have been described. For purposes of explanation, systems or configurations were set forth to provide an understanding of claimed subject matter. However, claimed subject matter may be practiced without those specific details. In other instances, well-known features were omitted or simplified so as not to obscure claimed subject matter. While certain features have been illustrated or described herein, many modifications, substitutions, changes or equivalents will now occur to those skilled in the art. It is, therefore, to be understood that the appended claims are intended to cover all such modifications or changes as fall within the true spirit of claimed subject matter.

1. A method of simulating application of one or more strategies for one or more actors comprising:
applying one or more sufficiently specified strategies for said one or more actors to one or more sufficiently specified scenarios for a selected number of periods via a special purpose computing device, said one or more sufficiently specified scenarios involving one or more other actors, said applying one or more sufficiently specified strategies taking into account responses of said one or more other actors to said one or more sufficiently specified strategies;
producing outcomes of said applying one or more sufficiently specified strategies for one or more actors to one or more sufficiently specified scenarios for a selected number of periods; and
evaluating performance of said one or more sufficiently specified strategies for one or more actors based at least in part on said outcomes.

2. The method of claim 1, wherein said one or more sufficiently specified strategies for one or more actors are specified in terms of decision rules capable of being implemented by said special purpose computing device.

3. The method of claim 2, wherein said decision rules are provided as statements in a conditional format capable of being implemented by said special purpose computing device.

4. The method of claim 2, wherein said evaluating performance of said one or more sufficiently specified strategies for one or more actors is determined in accordance with comparison of outcomes using one or more quantifiable measures of success.

5. The method of claim 4, wherein said evaluation performance of said one or more sufficiently specified strategies for one or more actors is determined at least in part by taking into account responses of said one or more other actors to said one or more sufficiently specified strategies in accordance with comparison of outcomes using one or more quantifiable measures of success.

6. The method of claim 1, wherein said applying one or more sufficiently specified strategies for one or more actors to one or more sufficiently specified scenarios for a selected number of periods comprises iteratively applying said one or more sufficiently specified strategies.

7. The method of claim 6, wherein said iteratively applying one or more sufficiently specified strategies for one or more actors to one or more sufficiently specified scenarios for a selected number of periods comprises taking into account responses of said one or more other actors on at least a particular iteration.

8. The method of claim 7, wherein said one or more sufficiently specified scenarios involving one or more other actors are specified at least in part in terms of decision rules capable of being implemented by said special purpose computing device.

9. The method of claim 8, wherein said one or more sufficiently specified scenarios or strategy changes are based at least in part on outcomes produced on said at least a particular iteration.

10. The method of claim 1, wherein at least one of said one or more actors or said one or more other actors are simulated to comprise at least one of the following: a market; a market segment; a stock market; weather; a political party; a sports team; a government; a governmental entity; a city; a state; a county; a political subdivision; a country; a business; a factory; a machine; a not-for-profit entity; an individual; a voter; a customer; a homeowner; a charity; or a committee or team of decision makers.

11. A method comprising:
applying one or more sufficiently specified strategies for one or more actors to one or more sufficiently specified scenarios for a selected number of periods via a special purpose computing device without any human intervention;
producing outcomes of said applying said sufficiently specified strategies, the number of possible outcomes being too large to be feasibly enumerated by a human and said applying said sufficiently specified strategies being too complex for feasible analytical solution; and
evaluating performance of said one or more sufficiently specified strategies for one or more actors based at least in part on said outcomes in accordance with one or more quantifiable measures.

12. The method of claim 11, wherein said applying one or more sufficiently specified strategies comprises applying one or more sufficiently specified strategies to one or more sufficiently specified scenarios involving one or more other actors, wherein said applying one or more sufficiently specified scenarios takes into account responses of said one or more other actors.

13. The method of claim 11, wherein said one or more sufficiently specified strategies comprise a set of decision rules specifying one or more actor decisions for any of said possible outcomes.

14. The method of claim 13, wherein said one or more sufficiently specified scenarios comprise being sufficiently specified so as to be capable of being implemented by said special purpose computing device.

15. The method of claim 14, wherein said decision rules are provided as statements in a conditional format capable of being implemented by said special purpose computing device.

16. The method of claim 11, wherein said one or more sufficiently specified scenarios comprises at least one of the following at least partially: ideal market competition; non-ideal market competition; non-market competition; collaboration; cooperation; independent behavior; disinterested behavior, or combinations thereof.

17. The method of claim 11, wherein said one or more quantifiable measures at least partially involving at least one of the following: market share, profits, revenue, costs, market capitalization, economic growth, cash flow, return on investment, customer satisfaction, employee satisfaction, win-loss percentage, stock price, election results, accident rates or combinations thereof.

18. The method of claim 11, wherein said evaluating performance of said one or more sufficiently specified strategies comprises comparing robustness or dominance of said one or more sufficient specified strategies.

19. The method of claim 14, wherein particular aspects of said one or more sufficiently specified scenarios are capable of changing independently in any period.

20. The method of claim 19, wherein said particular aspects of said one or more sufficiently specified scenarios are capable of changing non-linearly.

21. The method of claim 19, wherein said particular aspects of said one or more sufficiently specified scenarios are capable of changing discontinuously.

22. The method of claim 19, wherein said particular aspects of said one or more sufficiently specified scenarios are interconnected or inter-related.

23. The method of claim 11, and further comprising: identifying for all possible strategy combinations or permutations one or more of said sufficiently specified strategies for all possible strategy combinations or permutations based at least in part on the evaluation of performance.

24. The method of claim 11, wherein the number of possible sufficiently specified strategies to be evaluated is too large to feasibly evaluate performance for all possible strategy combinations or permutations;
wherein said evaluating performance of said one or more sufficiently specified strategies for one or more actors based at least in part on said outcomes in accordance with one or more quantifiable measures comprises evaluating performance of a subset of all possible strategy combinations or permutations; and further comprising:
identifying one or more of said sufficiently specified strategies for said one or more actors based at least in part on the evaluation of performance of the subset of all possible strategy combinations or permutations.

25. The method of claim 24, wherein said subset of all possible strategy combinations or permutations are selected based at least in part on evaluation of produced outcomes on any particular iteration.

26. An apparatus comprising: a special purpose computing platform, said special purpose computing platform being adapted to:
apply one or more sufficiently specified strategies for said one or more actors to one or more sufficiently specified scenarios for a selected number of periods, said one or more sufficiently specified scenarios to involve one or more other actors, said one or more sufficiently specified strategies to take into account responses of said one or more other actors to said one or more sufficiently specified strategies;
produce outcomes of said one or more sufficiently specified strategies for one or more actors being applied to one or more sufficiently specified scenarios for a selected number of periods; and
evaluate performance of said one or more sufficiently specified strategies for one or more actors based at least in part on said outcomes.

27. The apparatus of claim 26, wherein said one or more sufficiently specified strategies for one or more actors are specified in terms of decision rules capable of being implemented by said special purpose computing platform.

28. The apparatus of claim 26, wherein said special purpose computing platform is further adapted to: evaluate performance of said one or more sufficiently specified strategies for one or more actors in accordance with comparison of outcomes using one or more quantifiable measures of success.

29. The apparatus of claim 26, wherein said special purpose computing platform is further adapted to: apply said one or more sufficiently specified strategies for one or more actors to one or more sufficiently specified scenarios for a selected number of periods iteratively.

30. The apparatus of claim 29, wherein said special purpose computing platform is further adapted to: take into account responses of said one or more other actors on at least a particular iteration.

31. An apparatus comprising: a special purpose computing platform, said special purpose computing platform being adapted to:
apply one or more sufficiently specified strategies for one or more actors to one or more sufficiently specified scenarios for a selected number of periods;
produce outcomes of said sufficiently specified strategies, the number of possible outcomes being too large to be feasibly enumerated by a human and said sufficiently specified strategies being too complex for feasible analytical solution; and
evaluate performance of said one or more sufficiently specified strategies for one or more actors based at least in part on said outcomes in accordance with one or more quantifiable measures.

32. The apparatus of claim 31, wherein said special purpose computing platform is further adapted to: apply one or more sufficiently specified strategies to one or more sufficiently specified scenarios involving one or more other actors taking into account responses of said one or more other actors.

33. The apparatus of claim 31, wherein said one or more sufficiently specified strategies comprise a set of decision rules specifying one or more actor decisions for any of said possible outcomes.

34. The apparatus of claim 31, wherein said special purpose computing platform is further adapted to: identify for all possible strategy combinations or permutations one or more of said sufficiently specified strategies for all possible strategy combinations or permutations based at least in part on the evaluation of performance.

35. The apparatus of claim 31, wherein the number of possible sufficiently specified strategies to be evaluated is too large to feasibly evaluate performance for all possible strategy combinations or permutations; and
wherein said special purpose computing platform is further adapted to:
evaluate performance of a subset of all possible strategy combinations or permutations; and
identify one or more of said sufficiently specified strategies for said one or more actors based at least in part on the evaluation of performance of the subset of all possible strategy combinations or permutations.

36. The apparatus of claim 35, wherein said special purpose computing platform is further adapted to: select said subset of all possible strategy combinations or permutations based at least in part evaluation of produced outcomes on any particular iteration.

37. An article comprising: a storage medium having stored thereon instructions executable by a special purpose computing platform to:
apply one or more sufficiently specified strategies for one or more actors to one or more sufficiently specified scenarios for a selected number of periods, said one or more sufficiently specified scenarios to involve one or more other actors, said one or more sufficiently specified strategies to take into account responses of said one or more other actors to said one or more sufficiently specified strategies;
produce outcomes of said one or more sufficiently specified strategies for one or more actors being applied to one or more sufficiently specified scenarios for a selected number of periods; and
evaluate performance of said one or more sufficiently specified strategies for one or more actors based at least in part on said outcomes.

38. The article of claim 37, wherein said one or more sufficiently specified strategies for one or more actors are specified in terms of decision rules capable of being implemented by said special purpose computing platform.

39. The article of claim 38, wherein said instructions are further executable to: evaluate performance of said one or more sufficiently specified strategies for one or more actors in accordance with comparison of outcomes using one or more quantifiable measures of success.

40. The article of claim 37, wherein said instructions are further executable to: apply said one or more sufficiently specified strategies for one or more actors to one or more sufficiently specified scenarios for a selected number of periods iteratively.

41. The article of claim 40, wherein said instructions are further executable to: take into account responses of said one or more other actors on at least a particular iteration.

42. An article comprising: a storage medium having stored thereon instructions executable by a special purpose computing platform to:
apply one or more sufficiently specified strategies for one or more actors to one or more sufficiently specified scenarios for a selected number of periods;
produce outcomes of said sufficiently specified strategies, the number of possible outcomes being too large to be feasibly enumerated by a human and said sufficiently specified strategies being too complex for feasible analytical solution; and
evaluate performance of said one or more sufficiently specified strategies for one or more actors based at least in part on said outcomes in accordance with one or more quantifiable measures.

43. The article of claim 42, wherein said instructions are further executable to: apply one or more sufficiently specified strategies to one or more sufficiently specified scenarios involving one or more other actors taking into account responses of said one or more other actors.

44. The article of claim 42, wherein said one or more sufficiently specified strategies comprise a set of decision rules specifying one or more actor decisions for any of said possible outcomes.

45. The article of claim 42, wherein said instructions are further executable to: identify for all possible strategy combinations or permutations one or more of said sufficiently specified strategies for all possible strategy combinations or permutations based at least in part on the evaluation of performance.

46. The article of claim 42, wherein the number of possible sufficiently specified strategies to be evaluated is too large to feasibly evaluate performance for all possible strategy combinations or permutations; and
wherein said instructions are further executable to:
evaluate performance of a subset of all possible strategy combinations or permutations; and
identify one or more of said sufficiently specified strategies for said one or more actors based at least in part on the evaluation of performance of the subset of all possible strategy combinations or permutations.

47. The article of claim 46, wherein said instructions are further executable to select said subset of all possible strategy combinations or permutations based at least in part evaluation of produced outcomes on any particular iteration.

48. An apparatus comprising:
means for applying one or more sufficiently specified strategies for said one or more actors to one or more sufficiently specified scenarios for a selected number of periods, said one or more sufficiently specified scenarios to involve one or more other actors, said one or more sufficiently specified strategies to take into account responses of said one or more other actors to said one or more sufficiently specified strategies;
means for producing outcomes of said one or more sufficiently specified strategies for one or more actors being applied to one or more sufficiently specified scenarios for a selected number of periods; and
means for evaluating performance of said one or more sufficiently specified strategies for one or more actors based at least in part on said outcomes.

49. An apparatus comprising:
means for applying one or more sufficiently specified strategies for one or more actors to one or more sufficiently specified scenarios involving one or more other actors for a selected number of periods;
means for producing outcomes of said sufficiently specified strategies, the number of possible outcomes being too large to be feasibly enumerated by a human and said sufficiently specified strategies being too complex for feasible analytical solution; and
means for evaluating performance of said one or more sufficiently specified strategies for one or more actors based at least in part on said outcomes in accordance with one or more quantifiable measures.
